(19) United States
(12) Patent Application Publication
(10) Pub. No.: US 2007/0085942 A1
(43) Pub. Date: Apr. 19, 2007

(54) Sine-wave-like diffusion plate utilized in direct type backlight module of liquid crystal display

(75) Inventors: Huang-Chen Guo, Hsinchu (TW); Wann-Diing Tyan, Hsinchu (TW); Cheng-Lin Yang, Hsinchu (TW); Ying-Tsung Lu, Hsinchu (TW); Pong Lai, Hsinchu (TW); Chang-Sheng Chu, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/441,173

(22) Filed: May 26, 2006

(30) Foreign Application Priority Data
Oct. 19, 2005 (TW) 094136597

(51) Int. Cl. G02F 1/1335

(52) U.S. Cl. 349/61

(57) ABSTRACT

A sine-wave-like diffusion plate used in a backlight module of a liquid crystal display is provided. The diffusion plate is provided with an oppositely disposed first surface and second surface, and is used to receive and diffuse the light generated by a light source, and is characterized such, that the diffusion plate is provided with a sine-wave-like structure, optionally formed on the first surface and/or second surface.

### CROSS-REFERENCE TO RELATED APPLICATIONS

This non-provisional application claims priority under 35 U.S.C. § 119(a) on Patent Application No(s). 094136597 filed in Taiwan, R.O.C. on Oct. 19, 2005, the entire contents of which are hereby incorporated by reference.

### BACKGROUND OF THE INVENTION

1. Field of Invention

The invention relates to a diffusion plate structure and in particular to a sine-wave-like diffusion plate utilized in a direct type backlight module of a liquid crystal panel (LCD).

2. Related Art

Nowadays, the LCD is widely utilized in various portable electronic devices, such as a personal computer, digital camera, mobile phones, personal data assistant (PDA), Global Satellite Positioning System (GSPS), digital portable music player, etc. In the structure of the liquid crystal display, the LCD panel is the most essential element for display images. However, it does not emit light itself; instead its luminance is achieved by making use of a backlight module as the light source.

Presently, the backlight module can be classified as the edge lighting type and the direct type, wherein, for the edge lighting type backlight module, a light guidance plate (LGP) is used to guide the light coming from an end side surface to a front side through partial reflection and partial refraction, while for the direct type backlight module, a diffusion plate is used to diffuse the light coming from a plurality of direct type linear light sources evenly into an area light source, thus reducing the appearance of dark stripes and bright stripes. In general, for the large size (usually more than 20 inches) LCD products, the direct type backlight module, having higher light emitting efficiency, is utilized as the backlight source of the LCD panel.

For the related prior art, refer to published U.S. Pat. No. 2003/0184993, wherein a backlight module and an LCD are disclosed. They are characterized such, that in the diffusion plate of the backlight module, their surface structures are provided with a plurality of semi-hemispheres. Though with this structure, superior light diffusion can be achieved, the manufacturing of this direct type of diffusion plate has had difficulties and problems: in the process of assembling the diffusion plate into the direct type backlight module, its end portions are liable to be broken or collapsed due to collision, as such reducing the yield and quality of the direct type backlight module.

Therefore, the research and development of a diffusion plate structure of a direct type LCD backlight module, to raise its light diffusion efficiency while maintaining its production quality and yield, is the most important task in this field.

### SUMMARY OF THE INVENTION

In view of the above-mentioned problems and shortcomings of the prior art, the object of the invention is to provide a sine-wave-like diffusion plate utilized in a direct type backlight module of an LCD. Through the sine-wave-like structure and roughened surface of the diffusion plate, thus the light emitted by the light source can be diffused much more into the LCD panel, raising its light diffusion efficiency.

Therefore, to achieve the above-mentioned object, the invention provides a sine-wave-like diffusion plate of a backlight module, which is used to receive and diffuse the light generated by a light source. The diffusion plate is provided with a first surface and a second surface disposed opposite to each other, and it is characterized such, that the diffusion plate is provided with a sine-wave-like structure that is optionally formed on a first surface and/or a second surface, wherein the first and second surfaces are roughened surfaces, and the sine-wave-like structure is arranged into a one dimensional array or a two dimensional array.

In addition, in order to achieve the above-mentioned object, a direct type backlight module is disclosed by an embodiment of the invention, including: a light source, a sine-wave-like diffusion plate, which is provided with an oppositely disposed first surface and second surface, and is used to receive and diffuse the light generated by the light source, wherein a sine-wave-like structure is formed optionally on the first and/or second surface, such, that the sine-wave-like structure is arranged into a one dimensional array or a two dimensional array; and a reflection plate, which is used to reflect the light, generated by the light source, to the sine-wave-like diffusion plate.

Moreover, in order to achieve the above-mentioned object, an LCD panel is disclosed by another embodiment of the invention, including: a light source, a sine-wave-like diffusion plate, which is provided with an oppositely disposed first surface and second surface, and is used to receive and diffuse the light generated by the light source, wherein a sine-wave-like structure is formed optionally on the first and/or second surface, such, that the sine-wave-like structure is arranged into a one dimensional array or a two dimensional array; a reflection plate, which is used to reflect the light generated by the light source to the sine-wave-like diffusion plate; a brightness enhancement film (BEF), which is used to enhance the illuminance of the light source, and a liquid crystal (LC) panel, which is used to receive the light enhanced by the BEF.

Furthermore, in the embodiment of the invention, a high transmittance plastic plate is utilized to replace the low transmittance opal acrylic plate as a diffusion plate. The diffusion plate with the sine-wave-like structure and roughened surface is used to replace the particle diffusion plate, thus raising its light diffusion rate and efficiency.

As such, through the application of the sine-wave-like diffusion plate used in the direct type backlight module of LCD, much more light from the light source of the direct type backlight module may be diffused into the LC panel by making use of the characteristics of the sine-wave-like structure and its roughened surface, to raise its light diffusion rate and efficiency.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given in the illustration below only, and thus is not limitative of the present invention, wherein:

FIG. 1 is a schematic diagram of the structure of a direct type backlight module according to an embodiment of the invention;

FIG. 2A is a three-dimensional diagram of the structure of the sine-wave-like diffusion plate according to the first embodiment of the invention;

FIG. 2B is a three-dimensional diagram of the structure of the sine-wave-like diffusion plate according to the second embodiment of the invention;

FIG. 2C is a three-dimensional diagram of the structure of the sine-wave-like diffusion plate according to the third embodiment of the invention;

FIG. 2D is a three-dimensional diagram of the structure of the sine-wave-like diffusion plate according to the fourth embodiment of the invention;

FIG. 2E is a three-dimensional diagram of the structure of the sine-wave-like diffusion plate according to the fifth embodiment of the invention;

FIG. 3 is a schematic diagram indicating the diffusion and transmission of the incident lights through a sine-wave-like diffusion plate;

FIG. 4A is a diagram for a curve of the diffusion rate of relative intensity vs. diffusion angle according to the prior art; and

FIG. 4B is a diagram for a curve of the diffusion rate of relative intensity vs. diffusion angle according to the invention.

### DETAILED DESCRIPTION OF THE INVENTION

The purpose, construction, features, and functions of the invention can be appreciated and understood more thoroughly through the following detailed description with reference to the attached drawings.

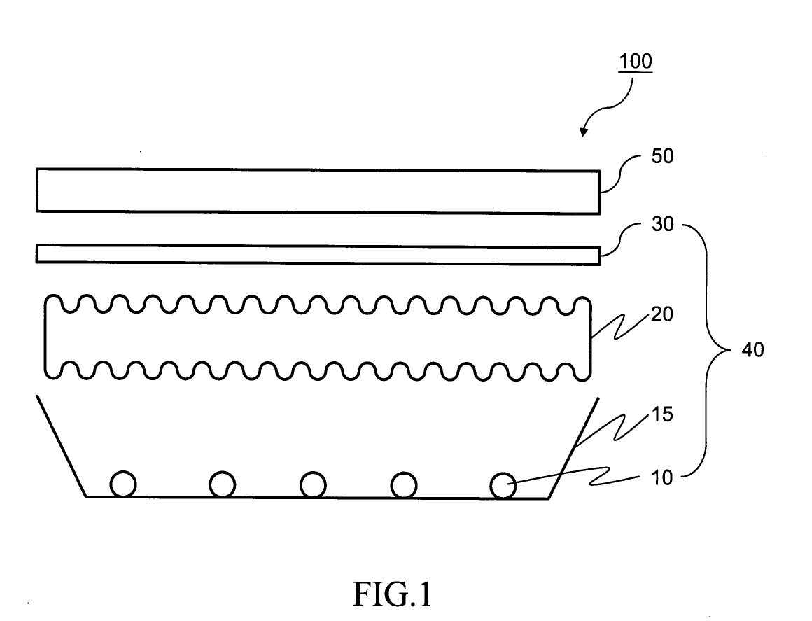

Refer to FIG. 1 for a schematic diagram of the structure of a direct type backlight module according to an embodiment of the invention, including: a light source 10, a reflection plate 15, a sine-wave-like diffusion plate 20, and a brightness enhancement film 30. The details of each device will be described as follows.

A light source 10 is used to generate light and is disposed on a reflection plate 15. In practice, the light source 10 may be a Cold Cathode Fluorescent Lamp (CCFL) or light-emitting-diode (LED) or another light-emitting device.

A reflection plate 15, is disposed behind the light source 10 and is formed in an open-mouthed shape, and is used to reflect the light generated by the light source 10 to the sine-wave-like diffusion plate 20. The angle of reflection and the reflectivity of the incident light can be changed by adjusting the open-mouthed angle of the reflection plate 15. In practice, the reflection plate 15 can be classified as a mirror reflection type, a diffusion reflection type, and a feedback reflection type.

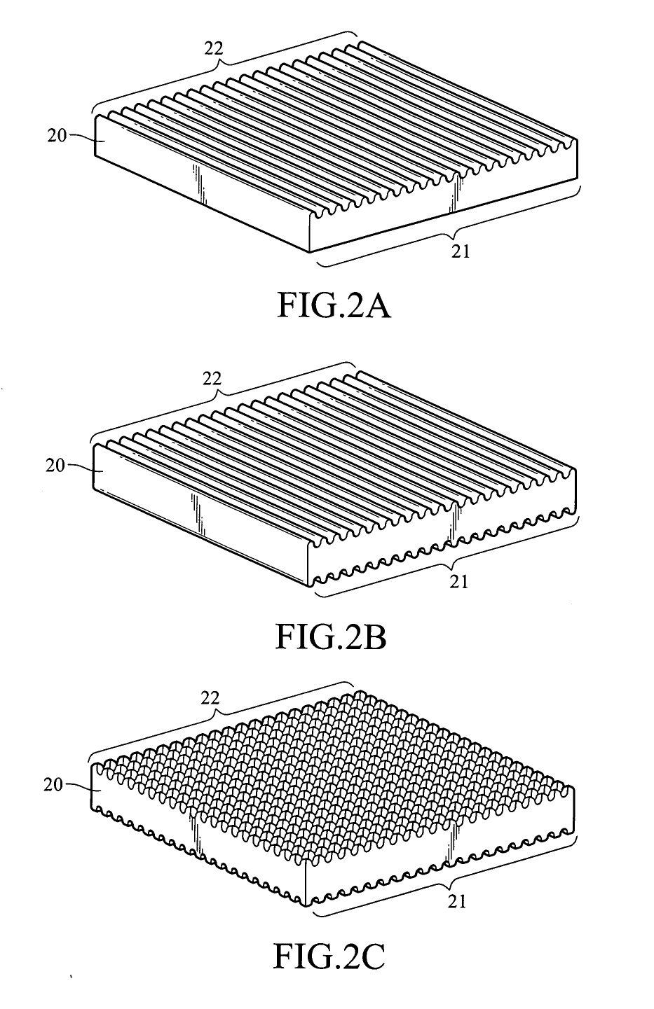

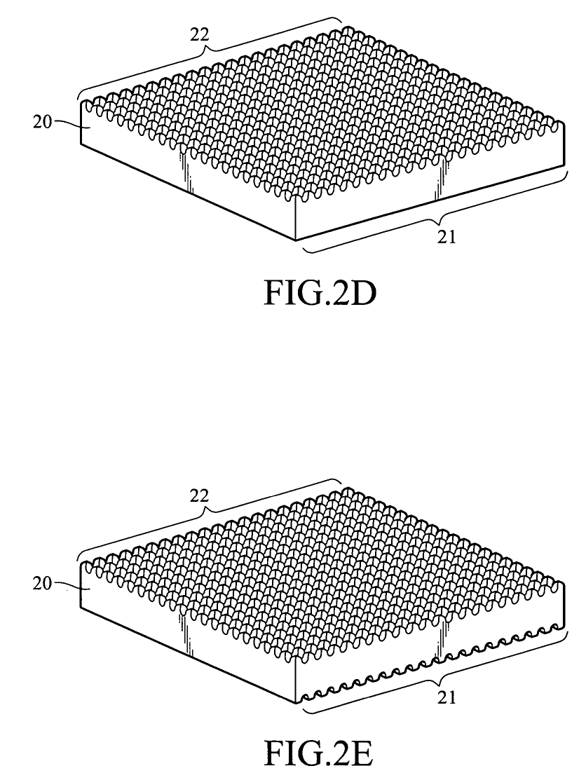

The sine-wave-like diffusion plate 20, is provided with an oppositely disposed first surface 21 and second surface 22 (as shown in FIG. 2B). The shape of the sine-wave-like structure is similar to that of a sine wave or cosine wave, and is used to receive and diffuse the light generated by the light source 10 to the brightness enhancement film 30. As such, the sine-wave-like structure may optionally be formed on the first surface 21 and/or the second surface 22, and be aligned in a periodic or non-periodic arrangement. Besides, the sine-wave-like structure of the first surface 21 and the second surface 22 can be formed into a one dimensional array of a two dimensional array, and they are further processed into roughened surfaces to raise the light diffusion efficiency.

The brightness enhancement film 30 is disposed in one side of the sine-wave-like diffusion plate 20, and is used to convert the linear light source to an area light source, thus increasing the intensity of the light generated by the light source 10. In practice, the brightness enhancement film 30 may be made of acrylic resin material. Moreover, only one brightness enhancement film 30 in FIG. 1 is taken as an example to explain the fact that the quantity of the brightness enhancement film 30 may be changed by the people with ordinary knowledge in this field, without departing from the spirit and scope of the invention.

In addition, the LCD panel 100 includes: a light source 10, a reflection plate 15, a sine-wave-like diffusion plate 20, a brightness enhancement film 30 and a liquid crystal (LC) panel 50. In this structure, except the LC panel 50, the rest elements belong to the direct type backlight module 40 just explained above, thus will not be explained here for brevity's sake.

The LC panel 50 is disposed in one side of the brightness enhancement film 30, and is used to receive the light enhanced by the brightness enhancement film 30, so that the LC panel 50 may display images of superior quality. The applications of different configurations of the sine-wave-like diffusion plate 20 in the first to fifth embodiment of the invention are described as follows.

Refer to FIG. 2A for a three-dimensional diagram of the sine-wave-like diffusion plate 20 according to the first embodiment of the invention, In such a structure, the first surface 21 is a plane and the second surface 22 is arranged into a sine-wave-like structure of a one-dimensional array, wherein the first surface 21 and/or the second surface 22 may be processed optionally into roughened surfaces to raise their light diffusion efficiency.

Refer to FIG. 2B for a three-dimensional diagram of the sine-wave-like diffusion plate 20 according to the second embodiment of the invention. In such a structure, the first surface 21 and the second surface 22 are both arranged into sine-wave-like structures of one-dimensional arrays, wherein the first surface 21 and/or the second surface 22 may be processed optionally into roughened surfaces to raise their light diffusion efficiency.

Refer to FIG. 2C for a three-dimensional diagram of the sine-wave-like diffusion plate 20 according to the third embodiment of the invention. In such a structure, the first surface 21 and the second surface 22 are both arranged as sine-wave-like structures of two-dimensional arrays, wherein the first surface 21 and/or the second surface 22 may be processed optionally into roughened surfaces to raise their light diffusion efficiency.

Refer to FIG. 2D for a three-dimensional diagram of the sine-wave-like diffusion plate 20 according to the fourth embodiment of the invention. In such a structure, the first surface 21 is a plane and the second surface 22 is arranged as a sine-wave-like structure of a two-dimensional array, wherein the first surface 21 and/or the second surface 22 may be processed optionally into roughened surfaces to raise their light diffusion efficiency.

Refer to FIG. 2E for a three-dimensional diagram of the sine-wave-like diffusion plate 20 according to the fifth embodiment of the invention. In such a structure, the first surface 21 is arranged as a sine-wave-like structure of a one-dimensional array and the second surface 22 is arranged as a sine-wave-like structure of a two-dimensional array, wherein, the first surface 21 and/or the second surface 22 may be processed optionally into roughened surfaces to raise their light diffusion efficiency.

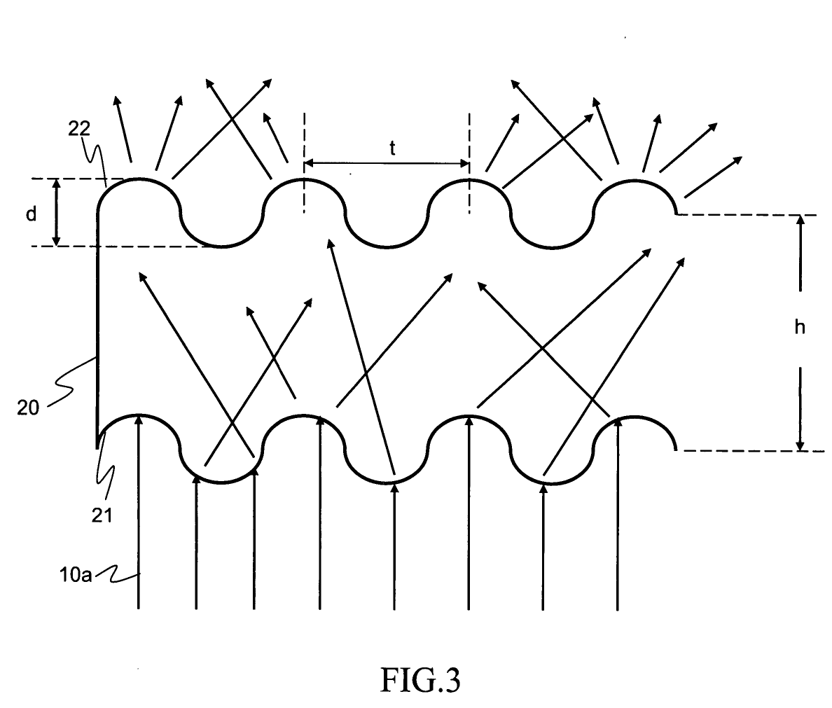

Subsequently, refer to FIG. 3 for a schematic diagram indicating the diffusion and transmission of the incident lights through a sine-wave-like diffusion plate 20. In such a structure of a sine-wave-like diffusion plate 20, the depth or amplitude of the respective sine-wave-like structure is d, and the periodic distance or spacing between each of the respective sine-wave-like structures is t, and the thickness of the sine-wave-like diffusion plate 20 is h. As such, upon penetrating the first surface 21 of the sine-wave-like diffusion plate 20, the light 10a, generated by a light source 10, is subject to the first deviation and diff-usion, and upon penetrating the second surface 22 of the sine-wave-like diffusion plate 20, the light 10a is subject to the second deviation and diffusion. In the above-mentioned structure, the periodic distance t of the sine-wave-like diffusion plate and the depth d of this plate are ranged from a few microns to hundreds of microns. Thus, the light transmittance and diffusion rate of the sine-wave-like diffusion plate 20 may be changed by adjusting the ratio of the periodic distance t, the micro-structure depth d and the structure thickness h of the sine-wave-like diffusion plate 20. In practice, the sine-wave-like diffusion plate 20 may be made of plastic material of high light transmittance.

Moreover, in the above description, the light, before entering the sine-wave-like diffusion plate 20, is represented by the parallel light 10a for simplicity. However, it is not intended to restrict that lights 10a generated by the light source 10 are all parallel lights.

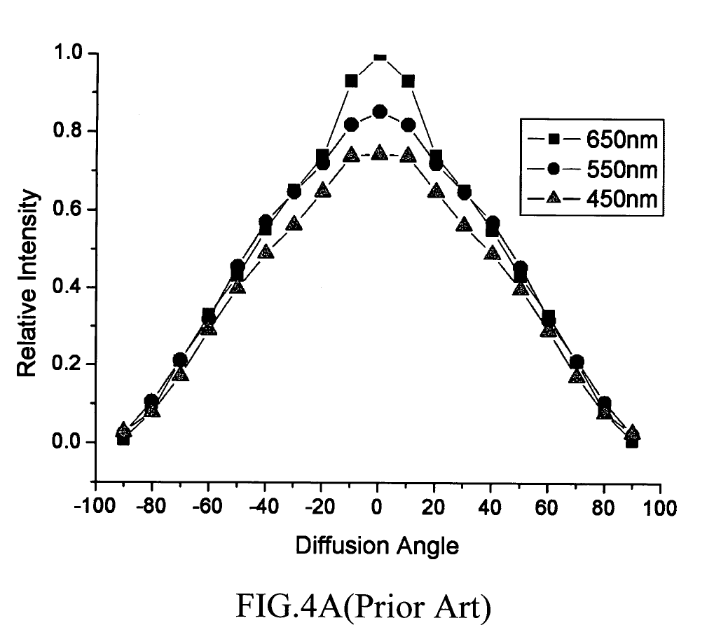

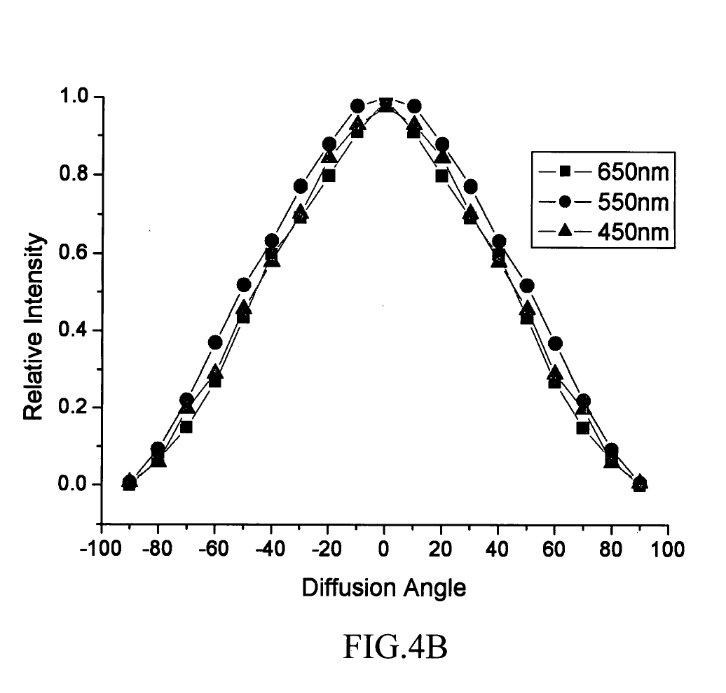

Finally, refer to FIG. 4A for a diagram for a curve of the diffusion rate of relative intensity vs a diffusion angle according to the prior art. As shown in FIG. 4A, the diffusion rate tests, conducted by making use of the lights of the light sources of wavelengths 450 nm, 550 nm and 650 nm are represented by the curves of dots of triangles, circles, and squares respectively, wherein the diffusion plate is made of opal acrylic. Meanwhile, refer to FIG. 4B for a diagram for a curve of the diffusion rate of relative intensity vs. diffusion angle according to the invention. As shown in FIG. 4B, the diffusion rate tests, conducted by making use of the lights of the light sources of wavelengths 450 nm, 550 nm and 650 nm are represented by the curves of dots of triangles, circles, and squares respectively, wherein the sine-wave-like diffusion plate is made of transparent plastic. From comparing the above two test results of diffusion rates, it is evident that a better diffusion angle and thus better diffusion range and efficiency can be achieved by making use of the sine-wave-like diffusion plate of the invention.

As such, through the application of the sine-wave-like diffusion plate used in the direct type backlight module of LCD, much more light from the light source of the direct type backlight module may be diffused into the LC panel, by making use of the characteristics of the sine-wave-like structure and its roughened surface, to raise its light diffusion rate and efficiency.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A sine-wave-like diffusion plate of a backlight module, used to receive and diffuse the light generated by a light source, and having an oppositely disposed first surface and second surface, and it is characterized that:
said diffusion plate is provided with a sine-wave-like structure, which is optionally formed on said first surface and/or second surface.

2. The sine-wave-like diff-usion plate of a backlight module as claimed in claim 1, wherein the surface of said sine-wave-like structure is a rough surface.

3. The sine-wave-like diffusion plate of a backlight module as claimed in claim 1, wherein said sine-wave-like structure of said sine-wave-like diffusion plate is formed on said first surface.

4. The sine-wave-like diffusion plate of a backlight module as claimed in claim 3, wherein said sine-wave-like structure is arranged into a one-dimensional array or two-dimensional array.

5. The sine-wave-like diffusion plate of a backlight module as claimed in claim 1, wherein said sine-wave-like structure of said sine-wave-like diffusion plate is formed on said second surface.

6. The sine-wave-like diffusion plate of a backlight module as claimed in claim 5, wherein said sine-wave-like diffusion structure is arranged into a one-dimensional array or a two-dimensional array.

7. The sine-wave-like diffusion plate of a backlight module as claimed in claim 1, wherein said sine-wave-like structure of said sine-wave-like diffusion plate is formed on said first surface and said second surface.

8. The sine-wave-like diffusion plate of a backlight module as claimed in claim 7, wherein said sine-wave-like diffusion structure is arranged into a one-dimensional array or a two-dimensional array.

9. The sine-wave-like diffusion plate of a backlight module as claimed in claim 1, wherein said sine-wave-like diffusion plate is made of a plastic material.

10. A direct type backlight module, comprising:
a light source;
a sine-wave-like diffusion plate having an oppositely disposed first surface and second surface, and is used to receive and diffuse the light generated by said light source, wherein, a sine-wave-like structure optionally formed on said first surface and/or second surface; and
a reflection plate, used to reflect the light generated by said light source to said sine-wave-like diffusion plate.

11. The direct type backlight module as claimed in claim 10, wherein the surface of said sine-wave-like structure is a rough surface.

12. The direct type backlight module as claimed in claim 10, wherein said sine-wave-like structure of said sine-wave-like diffusion plate is formed on said first surface.

13. The direct type backlight module as claimed in claim 12, wherein said sine-wave-like structure is arranged into a one-dimensional array or a two-dimensional array.

14. The direct type backlight module as claimed in claim 10, wherein said sine-wave-like structure of said sine-wave-like diff-usion plate is formed on said second surface.

15. The direct type backlight module as claimed in claim 14, wherein said sine-wave-like structure is arranged into a one-dimensional array or a two-dimensional array.

16. The direct type backlight module as claimed in claim 10, wherein said sine-wave-like structure of said sine-wave-like diffusion plate is formed on said first surface and said second surface.

17. The direct type backlight module as claimed in claim 16, wherein said sine-wave-like structure is arranged into a one-dimensional array or a two-dimensional array.

18. The direct type backlight module as claimed in claim 10, wherein said sine-wave-like diffusion plate is made of a plastic material.

19. A liquid crystal display (LCD) panel, comprising:
a light source;
a sine-wave-like diffusion plate having an oppositely disposed first surface and second surface, and is used to receive and diffuse the light generated by said light source, wherein a sine-wave-like structure optionally formed on said first surface and/or second surface;
a reflection plate, used to reflect the light generated by said light source to said sine-wave-like diffusion plate;
a brightness enhancement film, disposed in one side of said sine-wave-like diffusion plate, and is used to enhance the illuminance of the light coming from said light source; and
a liquid crystal panel, used to receive and diffuse the light enhanced by said brightness enhancement film.

20. The LCD panel as claimed in claim 19, wherein the surface of said sine-wave-like structure is a rough surface.

21. The LCD panel as claimed in claim 19, wherein said sine-wave-like structure of said sine-wave-like diff-usion plate is formed on said first surface.

22. The LCD panel as claimed in claim 21, wherein said sine-wave-like structure is arranged into a one-dimensional array or a two-dimensional array.

23. The LCD panel as claimed in claim 19, wherein said sine-wave-like structure of said sine-wave-like diffusion plate is formed on said second surface.

24. The LCD panel as claimed in claim 23, wherein said sine-wave-like structure is arranged into a one-dimensional array or a two-dimensional array.

25. The LCD panel as claimed in claim 19, wherein said sine-wave-like structure of said sine-wave-like diffusion plate is formed on said first surface and said second surface.

26. The LCD panel as claimed in claim 25, wherein said sine-wave-like structure is arranged into a one-dimensional array or a two-dimensional array.

27. The LCD panel as claimed in claim 19, wherein said sine-wave-like diffusion plate is made of a plastic material.
